(19) United States
(12) Patent Application Publication
(10) Pub. No.: US 2010/0306134 A1
(43) Pub. Date: Dec. 2, 2010

(54) System and method to establish and track fitness and diet for well-being

(76) Inventors: Roger Leslie Maxwell, Dallas, TX (US); Kathleen Wolfe Maxwell, Dallas, TX (US); Daveda Lamont-Tadeushuk, Yonkers, NY (US)

Correspondence Address: Roger L. Maxwell PC, Fifth Floor, 5307 E. Mockingbird Lane, Dallas, TX, 75206, US

(21) Appl. No.: 12/455,377

(22) Filed: Jun. 1, 2009

(51) Int. Cl. G06Q 90/00; B42D 15/00

(52) U.S. Cl. 705/500; 283/63.1

(57) ABSTRACT

A system to establish and track fitness and diet for well-being is disclosed. In a particular embodiment, a workbook includes at least one plan to improve well-being, instructions for following the at least one plan, forms to implement the at least one plan, and motivational aids.

### AUTHORIZATION LANGUAGE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### I. FIELD

The present disclosure is generally related to systems and methods to establish and track fitness and diet for well-being.

### II. DESCRIPTION OF RELATED ART

There are activities that are thought to help people improve their well-being. Likewise, there are diets that are thought to help people improve their well-being. Similarly, there are medications and nutritional supplements that are thought to help people improve their well-being. Still yet further, there are motivational aids that are thought to help people do what they need to do to improve their well-being.

While people can use certain types of books—such as journals—to keep track of their activities, diet, medications, and nutritional supplements, people do not have a single, unified book they can use to establish and track fitness and diet for well-being.

Because of the failure of the prior art to have a single, unified book people can use to establish and track fitness and diet for well-being, people have to try to use multiple books to have all the information they need or, even more frequently, people act without being aware of some activity, diet, medication, nutritional supplement, or motivational aid that exists and has been shown to be effective.

### III. SUMMARY

In a particular embodiment, a system to establish and track fitness and diet for well-being is disclosed. The system is a workbook for a reader/user. The workbook includes plans to increase well-being, instructions as to how to follow the plans, forms to implement the plans, and motivational aids.

In another particular embodiment, the workbook includes a blank area in which the reader/user can write in a plan provided to him or her by a healthcare advisor.

In another particular embodiment, the recovery workbook includes tests to enable the reader/user to select plans to implement.

In another particular embodiment, the workbook includes instructions to enable the reader/user to devise any specially needed plan.

In another particular embodiment, a method to establish and track fitness and diet for well-being of a person is disclosed. The method includes using a plan in a workbook, getting instructions for following the plan from the workbook, using forms in the workbook to implement the plan, and using material in the workbook for motivation to implement the plan.

One particular advantage provided by embodiments of the system and method to establish and track fitness and diet for well-being is the plans thought by the most qualified people known to be most successful are presented to the reader/user, together with forms that help him or her implement them.

Another particular advantage provided by embodiments of the system and method to establish and track fitness and diet for well-being is that it provides a tool—that is, completed forms—that can be used by a healthcare advisor to better understand the present level and particular needs of the person who completed the forms.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative embodiment of a system to establish and track fitness and diet for well-being; and

FIG. 2 is a flow chart of a particular illustrative embodiment of a method to establish and track fitness and diet for well-being.

### V. DETAILED DESCRIPTION

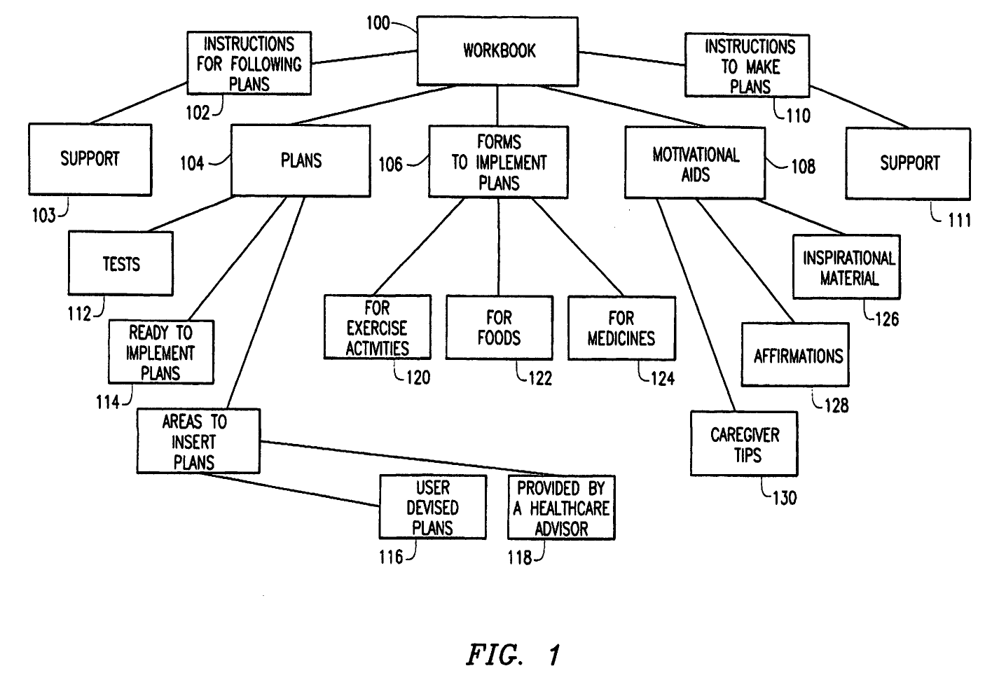

Referring to FIG. 1, a particular illustrative embodiment of a system to establish and track fitness and diet for well-being is disclosed and shown.

The system is a workbook 100. Workbook 100 includes instructions for following plans 102, plans 104, forms to implement plans 106, and motivational aids 108.

Workbook 100 is designed to enable a reader/user to improve their well-being. One way the reader/user can improve their well-being is to recover from an adverse medical event—such as a heart problem (like a heart attack or heart surgery), cancer (like breast cancer) or stroke (or other types of brain damage, such as that suffered by soldiers in a war zone). Another way they can improve their well-being is to “improve” from a generally undesired condition—such as from having a high weight or low energy level from a period of chronic inactivity or from a common human occurrence (like pregnancy). In such a case, “improvement” would be to reduce weight, increase energy, or the like. Yet another way they can improve their well-being is to enable themselves to perform some function better. For example, they can engage in activities and have a diet to “think better.” In such a case, improvement would be to function better (by, for example, learning faster, or having increased mental energy to learn more). Workbook 100 may assist people to improve their well-being any number of ways.

Someone who has had personal experience could write workbook 100. This would make workbook 100 a practical tool for a reader/user, and a tool that has been successfully used by someone in a similar position. There are alternatives, however. For example, the workbook 100 could be written by anyone—such as a researcher or healthcare advisor—who happens to have a personal or professional interest in the subject matter covered. The authors of this document expressly intend that the instant patent covers all workbooks as described herein, written by whomever.

Workbook 100 includes instructions for following plans 102. These instructions could be based on support 103 that may also be expressly set forth in workbook 100. The purpose of the support 103 is to provide a basis for the instructions 102. This basis could be scientific support and/or the personal experiences of the writer. In all cases, there are good reasons why the plans are what they are. The instructions 102 enable the reader to follow the plans, and when they have support 103, to understand why the plans are constructed as they are and how following the plans improve well-being.

Workbook 100 also includes plans 104. In various embodiments of the present invention the plans 104 may have different elements. For example, the plans 104 can include tests 112—such as tests 112 to enable a reader/user to determine areas in which “improvement” would be warranted and/or tests 112 to determine the amount of “improvement” made over a certain time period and/or other types of tests 112. It would be useful, for example, for a workbook 100 to include tests 112 to enable the reader/user to determine his or her “starting point” (when first beginning to use the workbook 100) and/or and to include tests 112 to enable the reader/user to determine his on her “ending point” (that is, the level of improvement attained when he or she finishes using the workbook 100). The tests can also help the reader/user determine what areas of improvement are desired by the reader/user.

Plans 104 can have other characteristics. For example, plans 104 can include a number of ready-to-implement plans 114, which are plans that a reader/user can immediately begin following with the aid of the forms 106 (discussed further below). There are situations, however, where special needs or resources available make it impractical for there to be a ready-to-implement plan 114 in the workbook 100. For those situations, the workbook 100 can include instructions on how to construct a plan 110 (possibly with support 111, such as scientific support and findings and findings based on the writer's personal experience) and, further, it can include blank spaces where the reader/user can write in his or her specially constructed plan 116. The inclusion of instructions for making a special plan 110 and space for writing down the special plan 116 make the workbook 100 universally useful, as whatever plan is needed by the reader/user is available or can be made available in the workbook 100. Further, the plans 104 included in the workbook 100 are also among the best plans known—because they have proven successful in the case of ready-to-implement plans or because they are formed based on principles that have proven to be successful, in the case of user-devised plans. The forms 106 in the workbook can be used with both ready-to-implement plans 114 and user-devised special plans 116.

The plans 104 can also include areas to insert plans provided by a healthcare advisor 118. A healthcare advisor can include, e.g., someone in the medical profession, an “alternative” practitioner of some sort or the other, a personal trainer, or anyone with special knowledge who could help a person “improve.” Including areas to insert plans provided by a healthcare advisor helps the reader/user deal with the situation in which he or she is given a special regime or plan by a healthcare provider to facilitate improvement. The reader/user can write in any plan provided to him or her by the healthcare advisor 118 and then use the forms 106 in the workbook 100 to follow it. Healthcare advisor-provided plans are good as they are professionally prescribed.

In addition to plans 104, the workbook 100 includes forms 106—such as weekly worksheets, and daily worksheets—that the reader/user can use to follow the plans. By way of example, weekly sheets could have areas in which the reader/user could record his or her measurements, weight, blood pressure, recent successes, goals, things to do for the upcoming week, and so on. Daily worksheets could have areas to record exercise activities, foods and drinks consumed, supplements taken, medicines taken, notes, reminders, and so on. The forms 106 can be used by the reader/user to track what he or she is doing (ideally in view of the plans 104 in effect) and where he or she is (in terms of weight, blood pressure, physical capabilities, and so on). Completed forms 106 can also be viewed by a healthcare advisor to give the advisor a quick, clear picture of where the reader/user is and what he or she can (and can't) do. This will enable the healthcare advisor to provide the reader/user with a plan ideally suited for them, which plan 118 can then be recorded in the workbook 100 and workbook forms 106 used to follow it. The forms 106 will typically have areas in which the reader/user can record his or her exercise activities 120, foods and drinks consumed 122, and medicines taken 124.

Included in workbook 100 are motivational aids 108. The motivational aids 108 may be inspirational material 126 such as quotations (included, for example, on each of the weekly worksheets). The motivational aids 108 may be drawings or photographs (for example, it could be useful to have “after” photographs of people who successfully improved in workbooks to encourage the reader/user to improve like them). The motivational aids 108 could be “affirmations” 128—statements of desirable intention or condition about the reader, his or her family or friends, or any aspect of the world. Conventionally, good affirmations are phrased in the first person and present tense (I am) rather than the future tense (I will). For example, “I am in perfect health in mind, body and soul” could be a good affirmation for a reader. As is known, when affirmations are deliberately contemplated and/or repeated, they more easily become firm intentions that are fixed in one's mind and consciousness. Affirmations mobilize inner resources. Affirmations become fact. Affirmations are an effective way to utilize and realize the power of positive intention.

The motivational aids 108 could be caregiver tips 130. Caregiver tips 130 are suggestions—such as how to communicate with the person using the book, and how to get assistance—that can be adopted by a person helping the reader/user improve using the workbook 100.

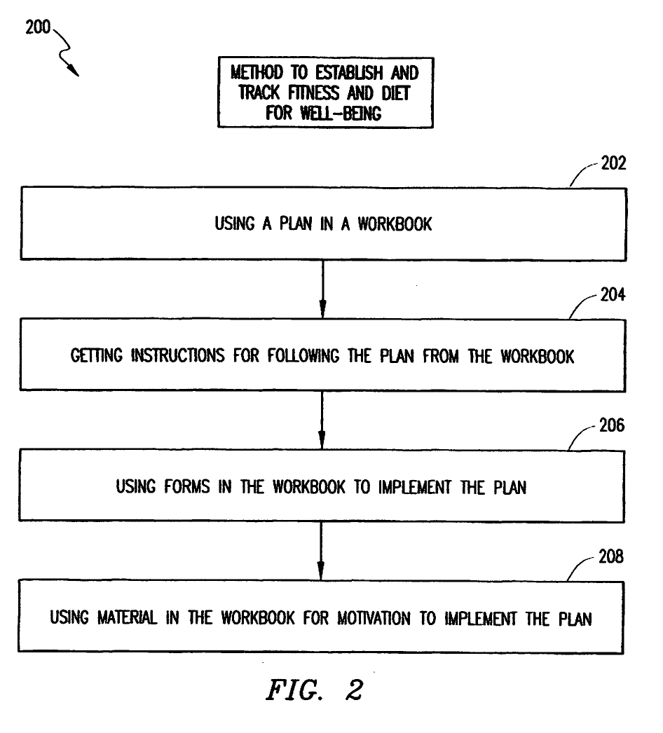

Referring to FIG. 2, a flow chart of a particular illustrative embodiment of a method to set and track recovery progress is disclosed and generally designated 200. At 202 a person uses a plan in a workbook. At 204, the person gets instructions for following the plan from the workbook. At 206, the person uses forms in the workbook to implement the plan. At 208, the person uses material in the workbook for motivation to implement the plan.

A patentable, example workbook is Taking Charge of Your Stroke Recovery: A Personal Recovery Workbook, published by Taking Charge Books, Inc., and written by the applicants of the instant patent application. This workbook “example” of a patentable system is included in this patent application's file. Taking Charge of Your Stroke Recovery: A Personal Recovery Workbook is copyrighted. © 2008 Roger Maxwell, Kathy Maxwell and Daveda Lamont-Tadeushuk.

The system and method of the present invention offers a number of advantages over the prior art. One particular advantage provided by embodiments of the system and method to establish and track recovery progress is that the recovery plans thought by the best people known to be successful are presented to the reader/user, together with forms that help him or her implement them. Another particular advantage provided by embodiments of the system and method to establish and track recovery progress is that it provides a tool—that is, completed forms—that can be used by a healthcare advisor to better understand the present level and particular needs of the reader/user.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A workbook to establish and track fitness and diet for well-being, comprising:
at least one plan to improve well-being;
instructions for following the at least one plan;
forms to implement the at least one plan; and
motivational aids.

2. The workbook of claim 1, wherein the workbook is designed for recovery from brain damage.

3. The workbook of claim 2, wherein the brain damage is caused by stroke.

4. The workbook of claim 1, wherein the workbook is designed for recovery from a heart attack or heart surgery.

5. The workbook of claim 1, wherein the workbook is designed for recovery from cancer.

6. The workbook of claim 1, wherein the workbook is designed for recovery from chronic inactivity.

7. The workbook of claim 1, wherein the workbook is designed to enhance well-being after pregnancy.

8. The workbook of claim 1, further comprising instructions to make at least one plan, wherein at least one plan is one of a plurality of plans, and wherein the plurality of plans include at least one ready-to-implement plan, and at least one blank area designed for the user to write in a self-devised plan.

9. The workbook of claim 8, wherein the plurality of plans further comprise at least one blank area designed to enable the user to write in a plan provided by a healthcare advisor.

10. The workbook of claim 1, wherein the at least one plan include at least one test for the user.

11. The workbook of claim 10, wherein the at least one test is designed to indicate the user's need for a plan.

12. The workbook of claim 11, wherein the at least one test is one of a plurality of tests, and wherein the at least one of a plurality of tests is designed to indicate the user's progress.

13. The workbook of claim 1, wherein the forms include at least one blank area to enable the user to record his or her activity.

14. The workbook of claim 13, wherein the forms further include at least one blank area to enable the user to record the foods and/or drinks consumed by him or her.

15. The workbook of claim 14, wherein the forms still further include at least one blank area to enable the user to record medicines taken by him or her.

16. The workbook of claim 1, wherein the motivational aids comprise inspirational material.

17. The workbook of claim 16, wherein the inspirational material comprises quotations, drawings, and photographs.

18. The workbook of claim 17, wherein the motivational aids further comprise affirmations.

19. The workbook of claim 18, wherein the motivational aids still further comprise caregiver tips.

20. A method to establish and track fitness and diet for well-being, comprising:
using a plan in a workbook;
getting instructions for following the plan from the workbook;
using forms in the workbook to implement the plan; and
using material in the workbook for motivation to implement the plan.
